(19) United States
(12) Patent Application Publication
(10) Pub. No.: US 2026/0225634 A1
(43) Pub. Date: Aug. 6, 2026

(54) Improved Foldable Golf Trolleys

(71) Applicant: MOTOCADDY LIMITED, Great Hallingbury, Hertfordshire (GB)

(72) Inventors: Paul STRAKER, Great Hallingbury, Hertfordshire (GB); Ian GELL, Great Hallingbury, Hertfordshire (GB); Kevin LINNELL, Great Hallingbury, Hertfordshire (GB); Cris SIMPSON, Great Hallingbury, Hertfordshire (GB)

(73) Assignee: MOTOCADDY LIMITED, Great Hallingbury, Hertfordshire (GB)

(21) Appl. No.: 19/154,955

(22) PCT Filed: Feb. 9, 2024
(86) PCT No.: PCT/EP2024/053328

§ 371 Date: Aug. 8, 2025

(30) Foreign Application Priority Data
Feb. 10, 2023 (GB) 2301899.7
May 16, 2023 (GB) 2307265.5

(51) Int. Cl. B62B 3/02; A63B 55/60; B62B 3/10; B62B 5/00

(52) U.S. Cl. CPC B62B 3/025; A63B 55/61; B62B 3/102; B62B 5/0053; A63B 2210/50

(57) ABSTRACT

A modular golf trolley includes a frame and a base, the frame and base each including at least one module. The frame module is semi-permanently attached the base. The modular golf trolley includes a lock arranged, in a locked configuration thereof, to maintain the semi-permanent attachment of the frame module to the base; and, in an unlocked configuration thereof, to permit reversible separation of the frame module from the base.

### FIELD

The present invention relates to golf trolleys and to foldable golf trolleys in particular.

### BACKGROUND

Foldable golf trolleys are those golf trolleys which may be reversibly deployed from a collapsed configuration to an expanded, unfolded configuration prior to use, and collapsed again for storage or transportation thereafter.

Both push-type, i.e. non-motorised, and electric (motorised) golf trolleys can be foldable. Foldable electric golf trolleys are typically more complex in design compared to foldable push-type trolleys given the requirement for an electromechanical drive mechanism including at least one battery, drivetrain and other powerable components. Wheel arrangements also typically differ between push-type and electric golf trolleys due to torque and other forces associated with driven wheels of electric golf trolleys.

Nevertheless, golfers desire ever more compact foldable golf trolleys, including foldable electric golf trolleys, so that space may be saved during their storage and transport. There is also a desire for more easily deployable and collapsible foldable golf trolleys, so that, for instance, assembly and disassembly time is reduced.

Additionally, electric golf trolleys, and particularly foldable electric golf trolleys, are electromechanical devices that can suffer relatively high rates of failure due to their complexity of design and typical use throughout the seasons and on varying terrain in comparison to push-type golf trolleys. This issue tends to be exacerbated by the development of more complex mechanisms aimed at producing more compact trolleys. A dichotomy exists.

Failure of a golf trolley usually requires shipping to a third party for rectification, which is costly, and environmentally unfriendly. Pertinently, the inventors have discovered that the transport of golf trolleys for service or repair can result in further damage to other parts of the trolley in transit, requiring additional repair, longer downtime, and additional cost to either the user or golf trolley producers. Also, users are left without the use of the golf trolley while it is repaired, regardless of which component or part of the golf trolley requires repair or replacement.

There is thus an ongoing need to improve the compactness, ease of use and utility of golf trolleys, while mitigating the impact of component failure.

The present invention aims to address these and other problems with the prior art.

### SUMMARY

Accordingly, in a first aspect, the present invention provides a modular golf trolley comprising a frame and a base having a chassis including at least first and second separable chassis modules. The chassis modules are reversibly separable from one another in a normal use configuration of the modular golf trolley.

As used herein, the term “normal use configuration” refers to the chassis modules of the modular golf trolley being expressly arranged to be separable from one another by a user. In other words, the modular golf trolley may be configured such that a user may separate the two or more chassis modules from one another when setting up or taking down the golf trolley prior to or after use, and/or during the course of play.

As used herein, the term “chassis module” generally refers to a segment of the body of the base, for example a segment other than (solely) a distinct detachable battery or battery pack, or a wheel, but which may include, be joined to or may house a battery, battery pack and/or one or more wheels. The base may include a first chassis module and a second chassis module.

Generally, as used herein the term “frame” refers to that part of the golf trolley which, in a deployed configuration of the golf trolley, may extend generally vertically from the base and may typically include a handlebar and at least part of a support for a golf bag.

The configuration of the present invention is advantageous because segments of the golf trolley, e.g. segments of the chassis of the base, are detachable from one another. This may make the golf trolley more compact in a separated configuration. Thus, the modular golf trolley may provide greater flexibility when transporting and storing the golf trolley between uses.

Also, importantly, the modular golf trolley allows different modules comprising different components or having different features to be interchangeably combined.

For example, a chassis module including a rear segment of the base and one or more push-type rear wheel attachments may be substituted for a chassis module including a rear segment of the base, one or more electric, i.e. motorised, rear wheel attachments and, optionally, means for applying drive to the electric wheel attachments. Therefore, a user need not purchase separate entire push-type and electric golf trolleys. Instead, they may purchase interchangeable push-type and electric modules in order to assemble several different types of modular golf trolley. This is particularly advantageous, because electric golf trolleys are often banned from golf courses during adverse weather conditions. Therefore, up until now, golfers are typically required to purchase both push-type and electric golf trolleys if they wish to use a golf trolley in all conditions.

Furthermore, if part of the modular golf trolley suffers a failure, only the module including that part can be sent off for repair or replacement instead of the whole golf trolley. Therefore, where the user owns another interchangeable module, they may continue to use the golf trolley.

Generally, and in embodiments, separation of the two or more modules from one another may be actuable without the use of a distinct tool (that is to say a tool which does not form an integral part of the golf trolley). For example, in embodiments, the modular golf trolley may comprise one or more quick-release mechanisms for separating a first chassis module from a second chassis module. The quick-release mechanism may include a push button or lever. Generally, such a quick-release mechanism may be operable between a locked position in which two corresponding said modules are joined to one another and are substantially inseparable (without actuation of the mechanism), and an unlocked position in which the two modules may be separated.

In embodiments, the modular golf trolley may be biased towards a locked configuration in which the separable modules are substantially inseparable without the actuation of a release mechanism or removal, or otherwise unlocking or release, of a locking means.

In embodiments, the modular golf trolley may include one or more additional modules which are separable from the remainder of the golf trolley. For example, the modular golf trolley may include three, four, five or more modules which are substantially separable from one another. For example, the frame may be substantially modular. In other words, the frame may constitute one or more separable modules, or submodules, which are separable from the base and/or one another. For example, the golf trolley may include a module including a steering means. In embodiments, the frame may comprise an upper portion and a lower portion. The lower portion may be separable from the upper portion. In embodiments, the frame may include at least part of a golf bag support. The at least part of the golf bag support may be separable from the remainder of the frame.

In embodiments, the first chassis module may constitute a front chassis module including one or more front wheel attachments. Generally, the or each front wheel attachment of the first chassis module may be a non-driven, i.e. passive, wheel attachment. However, in embodiments a front wheel attachment of the first chassis module may be a powerable wheel attachment, i.e. one which is driveable via one or more motors. In embodiments, the or each front wheel attachment may be a caster wheel attachment or a fixed wheel attachment.

In embodiments, the first, e.g. front, chassis module may be mechanically associated with, e.g. attached to, either permanently or semi-permanently, the frame. In embodiments, the frame may extend from the first chassis module in a deployed configuration of the golf trolley.

In embodiments, the second chassis module may constitute a rear chassis module including one or more rear wheel attachments.

As used herein, the term “wheel attachment” generally refers to an end portion of an axle configured to operably engage a wheel, with or without a wheel attached thereto, or a wheel including means, e.g. a socket, to receive at least part of an axle. The person skilled in the art will appreciate that golf trolley wheels may be independently separable from the golf trolley, e.g. for replacement or repair. A wheel attachment of a module may include one or more detachable wheels.

In embodiments, the second chassis module may be either a push-type module or an electric module. The push-type module may include one or more non-powered, i.e. non-motorised, wheel attachments. The electric module may include one or more powered, i.e. motorised, wheel attachments. In embodiments, the electric module may include a battery and/or one or more powerable (i.e. non-wheel) components. Preferably, the corresponding first chassis module may be configured to substantially interchangeably and reversibly attach to a push-type module and/or an electric rear module. Preferably the corresponding first chassis module may be configured to substantially interchangeably and reversibly attach to both a push-type module and an electric module.

Thus a single modular golf-trolley may be operated as both an electric golf trolley or a push-type golf trolley. This may allow it to be operated in a wider array of weather conditions, and/or aid repair.

In other words, the first chassis module may, for example, comprise a forward-most segment of the base chassis including one or more front wheel attachments and may be associated with, e.g. mechanically connected to, the frame. The first chassis module may be arranged to be connected with either a push-type or electric second chassis module comprising a rear-most segment of the base chassis including one or more rear wheel attachments.

It should be appreciated that, for brevity, the first chassis module is generally described herein as the front chassis module and the second chassis module is generally described herein as the rear chassis module, and that the first chassis module may alternatively be a rear-most segment of the base arranged to be connected with either a push-type or electric module comprising a forward-most segment of the base.

Generally, the push-type module may include one or more non-powered, i.e. push-type, wheel attachments.

Generally, the electric module may include one or more powerable wheel attachments, i.e. wheel attachments configured to be driven by one or more motors. In embodiments, a said electric module may comprise a battery configured to power the one or more powerable wheel attachments thereof. In embodiments, the electric module may comprise one or more motors and/or a drivetrain and/or transmission configured to deliver power, supplied by the battery, to the one or more powerable wheel attachments. In embodiments, the electric module may include one or more additional powerable components, e.g. which are not a battery, motor, drivetrain or transmission.

In embodiments, the first chassis module may include a battery and/or one or more powerable components. For example, the powerable wheel attachments of the second chassis module (and any other powerable components thereof) may be powered by a battery arranged at the first chassis module. In embodiments, the golf trolley may be provided with more than one battery.

In embodiments, the modular golf trolley may comprise more than two separable chassis modules which are generally attachable in a substantially linear configuration. A mid-chassis module may include a battery, one or more motors, a drive train, and/or one or more other powerable components. The mid-chassis module may be located substantially between the first and second chassis modules in an assembled state of the modular golf trolley.

In embodiments, the first chassis module may comprise an electrical connector, or electrical connector half, configured to operably engage a corresponding electrical connector half on a said electric second chassis module. As used herein, the term “electrical connector half” refers generally to a part or portion, e.g. plug, of an electrical connection between the part and one or more other parts, e.g. socket, when connected, and “electrical connector halves” similarly refers generally to first and second (or more) parts of an electrical connection, and not necessarily half by size or volume. In embodiments, the electrical connector may be a wired or a wireless connector, e.g. Bluetooth (RTM) or near-field communication (NFC). Thus, the chassis modules may be substantially electrically connected to one another when the golf trolley is in an assembled configuration. For example, the frame may be associated with the first, e.g. front, chassis module and may include one or more powerable components, e.g. an electronic user interface or GPS device, and the second, e.g. rear, chassis module may include a battery for powering the one or more powerable components of the frame in use, wherein the electrical connector halves operably engage in an assembled configuration of the golf trolley to confer power to the frame.

In embodiments, the golf trolley may be a foldable golf trolley. The foldable modular golf trolley may have a deployed configuration, e.g. a configuration in which the golf trolley is generally driveable, and a collapsed, e.g. substantially non-driveable, configuration.

In embodiments, the golf trolley may comprise one or more joints about which the golf trolley folds, in use, during a transition between the deployed and collapsed configurations. In embodiments, at least one said joint may be arranged substantially at or immediately adjacent the juncture between adjacent chassis modules such that the adjacent chassis modules fold relative to one another during a said transition.

In embodiments, at least part of the frame may be configured to move relative to the base during a transition between the deployed configuration and the collapsed configuration. In embodiments, during (e.g. at or following initiation of) a transition from the deployed configuration towards the collapsed configuration movement of the frame relative to the base and movement of the adjacent chassis modules may be substantially interdependent.

As used herein, reference to “during a transition” may include at or following initiation of a transition, or upon or substantially at completion of the transition, or at a mid-way stage, e.g. a certain amount of time elapsed, between initiation and completion of the transition. The performance actuated during the transition may also be completed after the transition itself has been completed.

Additionally or alternatively, in embodiments, during a transition from the collapsed configuration towards the deployed configuration, movement of the frame relative to the base and movement of the adjacent chassis modules may be substantially interdependent.

In a further aspect, the present invention provides a modular golf trolley comprising first, second and third chassis modules; wherein the first chassis module is substantially interchangeably attachable and reversibly separable from the second and third chassis modules in a normal use configuration of the modular golf trolley; and wherein the second and third chassis modules are substantially dissimilar, e.g. are different, to one another.

In embodiments, the first chassis module may be a front chassis module of the golf trolley. In other words, the first chassis module may correspond to a front portion of a golf trolley. In embodiments, the first chassis module may be mechanically associated with a frame of the modular golf trolley.

In embodiments, the second and third chassis modules may be rear chassis modules. In other words, the second and third chassis modules may correspond to a rear portion of a golf trolley.

In embodiments, the second chassis module may be a push-type module including one or more non-powered wheel attachments.

In embodiments, the third chassis module may be an electric module including one or more powerable wheel attachments and, optionally, one or more other powerable components.

Generally, the first chassis module may be configured to operably engaged with one or other of the second and third modules.

In embodiments, at least one said chassis module may be individually packaged. In embodiments, each said chassis module may be individually packaged. In other words, the chassis modules may be distinctly packaged such that they may be distributed and/or stored separately.

In embodiments, the modular golf trolley may be a foldable golf trolley.

In a further aspect, the present invention provides a chassis module for the modular golf trolley according to any preceding aspect. The chassis module is configured to reversibly engage a distinct corresponding chassis module in a normal use configuration of the modular golf trolley.

In embodiments, the chassis module may be mechanically associated with, e.g. attached to, the frame of the modular golf trolley. In embodiments, the frame may be reversibly detachable from the chassis module.

In embodiments, the chassis module may be a push-type module including one or more non-powered wheel attachments.

In embodiments, the chassis module may be an electric module including one or more powerable wheel attachments. In embodiments, the module may include a battery and/or one or more powerable components. For example, the module may include one or more motors, and/or a drivetrain.

In embodiments, the chassis module may be a front chassis module or a rear chassis module.

In a further aspect, the present invention provides a modular golf trolley comprising a frame and a base, and wherein the modular golf trolley includes at least first and second modules; wherein the separable modules are reversibly separable from one another in a normal use configuration of the modular golf trolley.

Thus, a user may attach two or more corresponding modules to one another in order to customise or upgrade a modular golf trolley by, for example, replacing a frame module having a non-GPS-enabled steering handle with a frame module having a GPS-enabled steering handle, without having to replace an entire golf trolley.

In embodiments, the modular golf trolley may be a foldable modular golf trolley. In embodiments, the foldable modular golf trolley may have a substantially deployed configuration and a substantially collapsed configuration.

In embodiments, the frame may substantially constitute a first module and the base may substantially constitute a second module. In other words, the frame and the base may be substantially reversibly separable from one another. In embodiments, the modular golf trolley may comprise substantially interchangeable modules. For example, a base module may be substantially interchangeably attached to one of a plurality of frame modules, or vice versa, which are each configured to attach to the base in substantially the same manner.

In embodiments, the frame may comprise a plurality of separable modules. For example, the frame may comprise an upper portion and a lower portion, wherein the upper and lower portions are reversibly separable from one another. In embodiments, the frame may include a steering means, e.g. a handlebar, and the steering means may be reversibly separable from the remainder of the frame.

In a further aspect, the present invention provides a modular golf trolley comprising a frame and a base, the frame and base each comprising at least one module; wherein a said frame module is semi-permanently attachable the base; the modular golf trolley comprising a locking means (e.g. a lock) arranged, in a locked configuration thereof, to maintain semi-permanent attachment of the frame module to the base; and, in an unlocked configuration thereof, to permit reversible separation of the frame module from the base.

As used herein, the term “semi-permanent” refers to the frame module being reversibly attachable to and separable from the base, the separability of the frame module and base being dependent on the configuration of the locking means (or lock), e.g. locked or unlocked, whose primary intended use is to facilitate repeatable separation and attachment of the frame module and base.

In other words, the frame module may be attached to the base in a manner which is substantially permanent in the absence of further intervention, via the locking means (or lock), but whose substantially permanent attachment may be undone through normal use by the user, i.e. not as part of an action which is not meant to be performed by the user, via the lock. This might be communicated to the user by an instruction manual, for example.

When the lock is in a locked configuration, the frame module and base are semi-permanently attached to one another. When the lock is in an unlocked configuration, the frame module and base may be separated from one another. The separation of the frame module and base, when the lock is unlocked, may optionally include one or more transitional actions, e.g. rotating, or otherwise releasing, the frame module and base, which is otherwise substantially prevented in the locked configuration of the lock. The lock may be at least partially separate from means provided for the one or more transactional actions. For the avoidance of doubt, “normal use” by the user is not intended to refer to repair or servicing of the golf trolley, or another action which is not typically expected of a golf trolley user.

In the unlocked configuration of the lock, the frame module may still be attached to or in contact with the base, albeit not semi-permanently attached thereto (as effected by the lock). The golf trolley may be substantially undriveable when the lock is in the unlocked configuration.

Herein, the terms “locking means” and “lock” are used substantially interchangeably.

This configuration is particularly advantageous because modules are reversibly detachable from one another, making the golf trolley more compact in a separated configuration.

Thus, the modular golf trolley provides greater flexibility when transporting and/or storing the golf trolley, e.g. between uses, or if part of the golf trolley must be transported for repair or disposal.

Furthermore, providing a modular golf trolley having the present configuration facilitates the improved customisation and design freedom of golf trolleys.

Semi-permanent attachment typically enables reversible separation of the frame module and base without a risk of damage to either part.

In embodiments, the lock may comprise a single-action lock. In other words, the lock may be transitioned between the locked and unlocked configurations thereof via the actuation of a lever, button or the like in substantially a single movement.

In embodiments, the locking means (or lock) may operably engage the frame module and/or base and, optionally, this may substantially include mechanical and/or magnetic engagement therewith. Operable engagement of the locking means (or lock) with a frame module and/or the base may or may not include physical engagement.

In embodiments, the locking means (or lock) may interlock with each of the frame module and the base.

In embodiments, the locking means (or lock) may be operable in a normal use configuration of the modular golf trolley. In other words, the frame module and base are expressly arranged to be separable from one another by a user in the course of normal use. Normal use may include, for example, the folding, unfolding, assembling and/or dismantling of the modular golf trolley by a user.

Generally, and in embodiments, reversible separation of the frame module and base from one another may be actuable without the use of a distinct tool. In embodiments, reversible separation of the frame module and base from one another may be actuable with the use of a distinct tool.

In embodiments, the locking means (or lock) may be arranged to substantially remain as part of the frame module and/or the base in the unlocked configuration thereof.

For example, the locking means may comprise at least two segments, wherein a first segment remains part of the frame module and a second segment remains part of the base in the unlocked configuration.

In an example, the locking means may comprise one or more clips, e.g. sprung clips, arranged on the frame module. The clips may be configured to operably engage a recess arranged on the base as the frame module and base are brought together.

In embodiments, the locking means may comprise a number of operably engaging magnetic contacts arranged correspondingly on the frame module and base.

In embodiments, the locking means or part thereof may be arranged to substantially separate from the frame module and base during a transition from the locked configuration towards the unlocked configuration.

In embodiments, the locking means may comprise one or more fixtures, e.g. screws, arranged to semi-permanently attach the frame module to the base.

In embodiments, the locking means may comprise a quick release mechanism.

For example, the locking means may comprise a quick release clamp, e.g. a cam lever clamp. In other words, the locking means may, in the locked configuration, apply a compressive force to compress the frame module and the base against one another such that they are substantially inseparable. Such a mechanism may typically allow straightforward adjustment of the locking means, e.g. a locking force, without the use of distinct tools.

In embodiments, the locking means may comprise a plurality of locking elements.

For example, the locking means may comprise a plurality of locking elements. In embodiments, each locking element may substantially prevent separation of distinct adjacent modules in a locked configuration of the locking means. In embodiments, during a transition from the locked configuration towards the unlocked configuration, two or more of the plurality of locking elements may substantially synchronously permit separation of distinct adjacent modules.

In embodiments, the modular golf trolley may comprise a plurality of locking means. In embodiments, two or more of the plurality of locking means may be substantially separately operable. Alternative, two or more of the plurality of locking means may be operable substantially in unison.

In embodiments, the locking means may be biased towards the locked configuration thereof when the frame module and base are connected. In embodiments, the locking means may be configured to overcome the bias via a manual intervention by a user. For example, the modular golf trolley may include a button, lever or the like which, when operably engaged, overcomes or otherwise eliminates the bias towards the locked configuration in order to transition the locking means from the locked configuration to the unlocked configuration and thus allow separation of the frame module and the base.

In embodiments, the modular golf trolley may be an electric golf trolley preferably including a battery and/or one or more powerable components.

In embodiments, the frame module may include an electrical connector configured to operably engage a corresponding electrical connector of the base, preferably when the locking means is in the locked configuration. The electrical connectors may typically facilitate an electrical, e.g. powered, connection between a battery of the golf trolley and one or more powerable components thereof when the connectors are connected. The electrical connectors may be at least partially, preferably substantially, housed within the frame module and/or base. For example, the electrical connector of the frame module including a tubular portion may be housed at least partially within the tubular portion. Thus, when the frame module and base are connected, the electrical connectors may inherently connect with one another without the need for a separate user-initiated action, e.g. the separate ‘plugging-in’ of an electrical connector. Therefore, both the physical and electrical connection of the frame module and base (or other separable modules) may occur substantially synchronously as part of a single user-initiated action.

In embodiments, the modular golf trolley may be configured such that the battery is substantially electrically disconnected from one or more powerable components of the frame in the unlocked configuration of the locking means.

In embodiments, the modular golf trolley may be arranged such that the battery is substantially electrically isolated, e.g. from one or more powerable components of the golf trolley, in the absence of the semi-permanent attachment of the frame module and base. Thus, the modular golf trolley is generally in a substantially non-powerable state when the frame module and base are separated. This may include, for example, the battery being substantially electrically disconnected from powerable components of the base (even though those components may not be mechanically separated therefrom).

In embodiments, the electrical connectors may include one or more non-power contacts. For example, the electrical connectors may include contacts configured to transfer data. The transferred data may relate to, for example, speed information or speed or directional controls to or from a user interface, battery level or health, fault information or other golf trolley status information, or golf course information.

In embodiments, one or more electrical connectors may be wired. In embodiments, one or more electrical connectors may be substantially wireless.

In embodiments, the electrical connectors may include make-last-break-first contacts, preferably one or more make-last-break-first power contacts. In other words, the electrical connectors may each include a power contact and one or more non-power contacts (e.g. data contacts). The power contacts may be configured to make contact with one another only substantially after each of the non-power contacts have contact one another. The power contacts may be configured to separate substantially before each of the non-power contacts separate. More specifically, in embodiments, the power contacts may be shorter in length than the non-power contacts in order that they contact one another only after the non-power contacts of the frame and base modules are connected. In embodiments, attachment of the frame module to the base may be at least partially through rotational movement (e.g. twisting or otherwise rotating) of the frame module relative to the base. In embodiments, the make-last-break-first electrical connectors may be arranged such that the power contacts contact one another towards or at the end of the rotational movement when the frame module is attached to the base, and/or to break at or near the beginning of the rotational movement when the frame module and base are separated.

In embodiments, the frame module or the base may include a socket arranged to receive a portion of the other of the frame module and base.

In embodiments, the said frame module or base may further comprise a bounding wall protruding from the socket, the bounding wall being configured to substantially circumferentially bound the other of the frame module and base. The frame module or base may substantially permanently or temporarily received by the socket and bound the bounding wall of other of the frame module and base.

In embodiments, the base may comprise a chassis including a cut out, e.g. recess, and the frame module may include a portion which substantially occludes the cut out, e.g. recess when the frame module is semi-permanently attached to the base.

In embodiments, the modular golf trolley may be a foldable golf trolley. The foldable modular golf trolley may be reversibly deployable from a collapsed configuration to a deployed configuration.

In embodiments, the modular golf trolley may comprise a cam mechanically associated with the folding and unfolding of the modular golf trolley. For example, the cam may be associated with the folding and unfolding of a first chassis module relative to a second chassis module.

In embodiments, the cam may be formed by interfacing portions of the frame module and base.

In embodiments, one of the frame module and base may include a recess and the other may include a corresponding protrusion, e.g. tooth, configured to operably engage the recess preferably such that, in the locked configuration of the locking means, relative movement of the frame module and base portion is substantially prevented. In other words, relative movement of constituent parts of the cam may be substantially prevented.

In embodiments, the locking means may comprise a rod and the frame module and base may each include one or more openings configured to receive the rod. In embodiments, the rod may be in the form of the shank and thread of a screw.

In embodiments, a said opening of the frame module may be formed as a slot extending from an extremity thereof. Thus, the frame module may be more straightforwardly detachable from the base in the unlocked configuration of the locking means. For example, the frame module may be straightforward lifted away from the base without the need to remove the rod from the openings of the base.

In embodiments, the frame may include an upper portion and lower portion. The upper and lower portions may be pivotally connected to one another. In embodiments, the frame may include a steering means. In embodiments, the upper portion, lower portion, and steering means may substantially comprise one frame module. Alternatively, the upper portion, lower portion, and steering means may comprise two or more reversibly separable frame modules which are reversibly separable in a normal use configuration of the modular golf trolley.

In embodiments, the base may comprise a chassis including at least first and second separable chassis modules, as described above. In embodiments, the chassis modules may be reversibly separable from one another in a normal use configuration of the modular golf trolley.

In a further aspect, the present invention provides a frame module for the modular golf trolley according to any preceding aspect.

In embodiments, the frame module may be configured to be semi-permanently attached to a base module. The frame module may include at least part of a lock as described above.

In a further aspect, the present invention provides a kit for a modular golf trolley comprising two or more modules according to any preceding aspect. In embodiments, the present invention provides a kit including a single such module and instructions to combine the module with another such module.

In embodiments, the kit may comprise a base and one or more frame modules. In embodiments, the kit may comprise one or more base modules.

In embodiments, the kit may comprise a first chassis module and a second chassis module, the first chassis module being a front chassis module and the second chassis module being a rear chassis module. In embodiments, the kit may comprise two second chassis modules, the second chassis modules being substantially dissimilar from, i.e. different to, one another. In other words, one said rear chassis module may be a push-type module and the other said rear chassis module may be an electric module.

In embodiments, the kit may comprise one or more frame modules. For example, in embodiments, the kit may comprise a modular steering means, e.g. a steering handle module attachable to a frame module.

In embodiments, the kit may be a starter kit for a modular golf trolley, including one or more modules according to any preceding aspect.

The starter kit may comprise at least one base module and at least one frame module. In embodiments, the or each base module and the or each frame module of the starter kit may be configured to be assembled into a substantially complete, e.g. driveable, modular golf trolley. In other words, a plurality of modules may be provided as part of a starter kit which, when assembled together, form a substantially complete golf trolley (push and/or electric).

The kit may be packaged in a substantially assembled, partially assembled (e.g. substantially assembled, but for a battery) or a disassembled arrangement. The kit may be packaged together or in separate packages, e.g. for safety.

The kit may be suitable for a modular golf trolley according to any preceding aspect.

In a further aspect, the present invention provides a method of assembling a modular golf trolley comprising the steps of:
a) providing first and second modules and a locking means (or lock) according to any preceding aspect;
b) connecting a first module to a second module;
c) transitioning the locking means from an unlocked configuration, in which reversible separation of the first module and second module is substantially permitted, to a locked configuration in which the first module and second module are semi-permanently attached to one another.

In embodiments, the first module may be a frame module and the second module may be a base module. In embodiments, both the first and second modules may be base modules, e.g. chassis modules.

In embodiments, step c) may be reversible. In embodiments, step c) may be repeatable.

In embodiments, steps b) and c) may occur substantially simultaneously.

In embodiments, step c) may occur in a normal use configuration of the modular golf trolley.

In embodiments, the modular golf trolley may be an electric golf trolley, including a battery and one or more powerable components.

In embodiments, step b) and/or step c) may include electrically connecting the one or more powerable components to the battery.

In embodiments, during a transition from the locked configuration to the unlocked configuration of the locking means, the battery may be electrically isolated.

In a further aspect, the present invention provides a foldable golf trolley comprising a frame and a base including a first chassis segment including one or more front wheel attachments and a second chassis segment including one or more rear wheel attachments. The foldable golf trolley is configured to transition between a deployed configuration and a collapsed configuration.

In the deployed configuration, the frame substantially extends from the first chassis segment. For example, the frame may be hingedly connected to the first chassis segment by a hinge or the like.

During a transition between the deployed configuration and the collapsed configuration the second chassis segment moves relative to the first chassis segment and the frame.

As discussed, golfers require ever more compact foldable golf trolleys so that they may be stored and transported more straightforwardly. Providing a foldable golf trolley in which a rear-most chassis segment including one or more wheel attachments is foldable relative to a forward-most chassis segment and the frame, where the frame extends from the first chassis segment, provides a more compact foldable golf trolley.

Up until now, the foldability of electric foldable golf trolleys has been limited by the location of any batteries and powerable components which are typically housed or located towards the rear of the golf trolley. Therefore, providing a forward-most chassis segment which folds relative to the frame and the rear-most chassis segment during a transition between deployed and collapsed configurations has been favoured.

By contrast, in the present invention the second chassis segment, which is the rear and typically more bulky segment in foldable electric golf trolleys is foldable relative to the first chassis segment and the frame (which extends from the first chassis segment).

In embodiments, the foldable golf trolley may be configured such that, in the collapsed configuration, the first chassis segment is positioned between the frame and the second chassis segment. Whereas, in prior foldable golf trolleys, a rear portion of the base typically abuts the frame in a collapsed configuration, in the present invention the rear chassis segment is instead separated from the frame by the first chassis segment in the collapsed configuration. This provides a more compact golf trolley in the collapsed, or folded, configuration.

Typically, the frame and second chassis segment may each be hingedly connected to the first chassis segment by a hinged connection. In embodiments, both hinged connections may be located towards a rear portion of the first chassis segment. In embodiments, both hinged connections may be in substantially the same plane as one another.

In embodiments, during a transition between the deployed and collapsed configurations, the frame may rotate about its hinged connection with the first chassis segment in a first direction and the second chassis segment may rotate about its hinged connection with the first chassis segment in a second direction, the second direction being substantially opposite to the first direction.

In embodiments, the foldable golf trolley may be an electric golf trolley. In embodiments, the second chassis segment may comprise a battery and one or more powerable wheel attachments, i.e. motorised wheel attachments, which may be powered by the battery via the motor. In other words, the second chassis may comprise one or more wheel attachments (e.g. an axle, with or without a wheel attached thereto) which are powerable by the battery.

In embodiments, the second chassis segment may comprise one or more components configured to deliver power to the one or more powerable wheel attachments. For example, the second chassis segment may comprise one or more motors, a drivetrain and/or transmission.

Thus, the electromechanical drive mechanism of the foldable electric golf trolley may be housed substantially within the second chassis segment.

In embodiments, the first chassis segment may comprise a first electrical connector and the second chassis segment may comprise a corresponding electrical connector. Preferably, the electrical connectors may be configured to operably engage one another in the deployed configuration of the foldable golf trolley.

In embodiments, during a transition from the deployed configuration towards the collapsed configuration at least part of the frame may move relative to the first chassis segment, and movement of the frame relative to the first chassis segment and movement of the second chassis segment relative to the first chassis segment and the frame may be substantially interdependent.

Additionally or alternative, in embodiments, during a transition from the collapsed configuration towards the deployed configuration, at least part of the frame may move relative to the first chassis segment, and movement of the frame relative to the first chassis segment and movement of the second chassis segment relative to the first chassis segment and the frame may be substantially interdependent.

In other words, the frame and the second chassis segment may be movably coupled to one another such that they are substantially prevented from moving independently to one another.

Thus, in embodiments, the foldable golf trolley may comprise a one-step folding mechanism: the mechanics for folding the frame relative to the first chassis segment and the mechanics for folding the second chassis segment relative to the first chassis segment and the frame being substantially operably linked. Thus, a user need only make a single manual action to fold the foldable golf trolley from the deployed configuration to the collapsed configuration and/or to unfold the foldable golf trolley from the collapsed configuration to the deployed configuration.

In embodiments, during a transition between the deployed and collapsed configurations, the first chassis segment may rotate relative to a wheel thereof with the wheel remaining substantially static, on the ground, during a said transition.

In embodiments, the frame and the second chassis segment may be mechanically connected to one another such that their interdependent movement is substantially synchronous. Alternatively, in embodiments, the golf trolley may be arranged such that movement of the frame and the second chassis segment may be substantially non-synchronous during a transition between the deployed and collapsed configurations.

In embodiments, the second chassis segment may be hingedly connected to the first chassis segment at or towards an underside of the base by a hinged connection. In embodiments, during a transition from the deployed configuration towards the collapsed configuration the second chassis segment may be configured to rotate about the hinged connection such that, in the collapsed configuration, an underside of the second chassis segment substantially faces an underside of the first chassis segment of the base.

In embodiments, the second chassis segment may include a pair of rear wheel attachments. In embodiments, the foldable golf trolley may be configured such that, in the collapsed configuration, the pair of rear wheel attachments substantially flank the first chassis segment.

In embodiments, the second chassis segment may be a separable module which is reversibly separable from the rest of the golf trolley in a normal use configuration of the golf trolley.

The separable module may comprise any of the features described above with respect to any prior aspect.

Where the electromechanical drive mechanism of the foldable golf trolley is housed substantially within the second chassis segment, this chassis segment may therefore be more easily detached from the remainder of the golf trolley.

In embodiments, the separable module may be a push-type module including one or more non-powered wheel attachments, or the separable module may be an electric module including one or more powerable wheel attachments, wherein the first chassis segment is configured to substantially interchangeably and reversibly attach to the second chassis segment.

In embodiments, the module may include a battery and/or one or more powerable components, for example one or more motors and/or a drivetrain or transmission.

In a further aspect, the present invention provides a modular golf trolley according to any preceding aspect or combination of aspects. In embodiments, the modular golf trolley may comprise a frame having one or more submodules, and a base having one or more submodules. In embodiments, the modules and/or submodules may be separably attachable to one another. In embodiments, the modular golf trolley may include at least first and second modules. In embodiments, the separable modules may be reversibly separable from one another in a normal use configuration of the modular golf trolley.

For the avoidance of doubt, features of aspects and embodiments described herein may be combined, and still fall within the scope of the present invention.

### BRIEF DESCRIPTION OF FIGURES

Preferred features of the present invention will now be described, by way of example, with reference to the accompanying drawings, in which:

FIG. 1 illustrates a view of a modular and foldable golf trolley according to the present invention, with detached chassis modules.

FIG. 2 illustrates a view of a modular and foldable golf trolley according to the present invention.

FIG. 3 illustrates a view of a modular and foldable golf trolley according to the present invention, with detached chassis and frame modules.

FIG. 4 illustrates a perspective view of part of a modular golf trolley including reversibly separable frame and base modules.

FIG. 5 illustrates a side on view of a modular golf trolley according to the present invention, with a locking means in a locked configuration thereof.

FIG. 6 illustrates a side on view of a modular golf trolley according to the present invention, with a locking means in an unlocked configuration thereof.

FIG. 7 illustrates a top down view of the base of the modular golf trolley of FIGS. 4, 5 and 6.

FIG. 8 illustrates a view from below of a frame module.

FIG. 9 illustrates a side on view of frame and base modules of a modular golf trolley according to the present invention.

FIG. 10 illustrates a frame module portion and base module portion of a modular golf trolley according to the present invention.

FIG. 11 illustrates a sectional view of frame and base modules in an electrically disconnected configuration.

FIG. 12 illustrates a sectional view of frame and base modules in an electrically connected configuration.

FIGS. 13, 14 and 15 illustrate sectional views of frame and base modules in a separated arrangement, a partially separated and an in-use arrangement, respectively.

FIGS. 16 and 17 illustrate perspective views of a frame module.

FIGS. 18, 19 and 20 illustrate modules including electrical connector halves.

FIG. 21 illustrates a view from the side of a modular golf trolley in a folded configuration.

FIG. 22 illustrates a view from the side of a modular golf trolley in a partially folded configuration including a locking means in a substantially locked configuration.

FIG. 23 illustrates a view from the side of a modular golf trolley in a partially folded configuration including a locking means in a substantially unlocked configuration.

FIG. 24 illustrates a view from the side of a modular golf trolley wherein frame and base modules thereof are separated.

### DETAILED DESCRIPTION

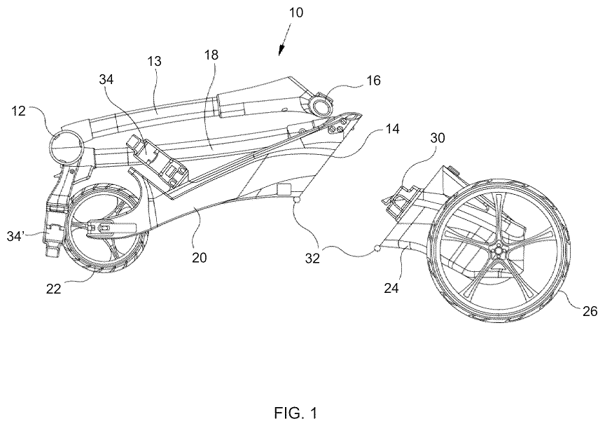

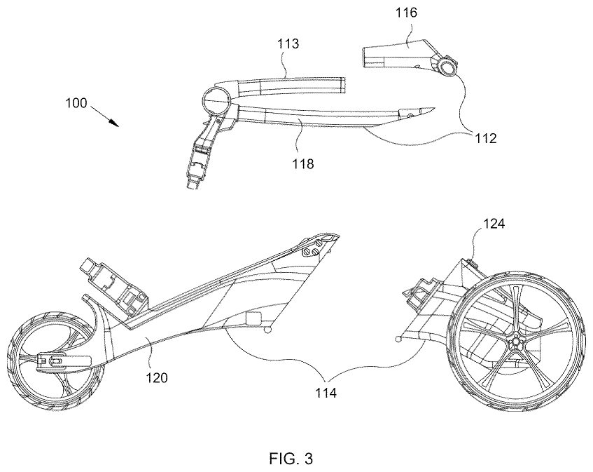

FIG. 1 shows a modular and foldable golf trolley according to the present invention, referenced generally as 10. Generally, the golf trolley 10 includes a rear chassis segment which is both foldable relative to a front chassis segment of the golf trolley base and which is a separable module reversibly detachable from the rest of the golf trolley. The golf trolley 10 may also include additional reversibly separable modules, as described in greater detail below with reference to FIG. 3.

Referring still to FIG. 1, the detachable rear chassis module of the figures comprises powerable wheel attachments and means for driving the powerable wheel attachments, e.g. a battery and/or drivetrain, such that electromechanical drive components of the golf trolley 10 may be substantially entirely separable from the rest of the golf trolley 10. Thus, the golf trolley 10 may be converted between electric and non-electric, i.e. push, states through the interchangeable attachment of push-type and electric rear chassis segments to the front chassis segment (which is compatible with both electric and push-type rear chassis modules).

The golf trolley 10 generally includes a frame 12 and a base 14. Two parts of a support 34, 34′ for a golf bag are located on the frame 12 and base 14. The base comprises a chassis, i.e. a body, and a plurality of wheel attachments including wheels.

The frame 12 is comprised of an upper portion 13 having a steering means 16. The upper portion 13 is hingedly connected to a lower portion 18 of the frame 12, which is itself hingedly connected to the base 14.

The golf trolley 10 is configured to transition between a deployed configuration, in which the golf trolley 10 is generally driveable, and a collapsed, i.e. non-driveable, configuration. Together, the upper and lower portions 13, 18 of the frame 12 are foldable during a transition from deployed configuration to the collapsed configuration of the golf trolley 10 to a substantially concertinaed configuration. In the collapsed configuration, the upper portion 13 lies against the lower portion 18 and the lower portion 18 lies between the upper portion 13 of the frame and the base 14.

Referring still to FIG. 1, the lower portion 18 of the frame 12 is hingedly connected to a first chassis segment 20 of the base 14. The frame 12 is arranged to extend substantially vertically from the first chassis segment 20 in the deployed configuration of the golf trolley 10. The first chassis segment 20 comprises a part of the body of the base 14 and a wheel attachment 22 including a non-driven, i.e. passive, wheel.

A second chassis segment 24 comprises a distinct part of the body of the base 14 and a wheel attachment 26 including, in the embodiment of FIG. 1, two driven, i.e. powerable, wheels (only one of which is shown). The second chassis segment 24 is thus an electric segment and, as a result, the golf trolley 10 is an electric golf trolley. The wheels of the first and second chassis segments 20, 24 are generally detachable from the respective chassis segment.

In FIG. 1, the first chassis segment 20 is a forward segment of the base 14 and the second chassis segment 24 is a rear segment of the base 14. The first chassis segment is therefore the segment which is typically forward-most when the golf trolley is manoeuvred by a user, i.e. pushed or propelled forwards, and the second chassis segment is therefore the segment which is rear-most during use. For the avoidance of doubt, in use, the wheel attachment 22 of the first chassis segment 20 typically travels ahead of the wheel attachments 26 of the second chassis segment 24.

The first and second chassis segments 20, 24 comprise distinct modules which are reversibly separable from one another in a normal use configuration of the golf trolley 10. While the second chassis segment 24 of FIG. 1 is an electric segment, the second chassis segment 24 may instead comprise a non-electric, i.e. push-type segment which is interchangeable with the second chassis segment of FIG. 1. When a push-type segment is operably engaged with the first chassis segment, the golf trolley 10 is effectively a push-type golf trolley.

Referring in more detail to the second chassis segment 24 in FIG. 1, the electric segment 24 comprises the means required for driving the two powerable wheels thereof, including a battery and a drivetrain for applying power derived from the battery to the powerable wheels during use. Thus, the second chassis segment 24 is reversibly separable from the first chassis segment 20 substantially without the need to separate the electromechanical drive mechanism of the golf trolley 10.

The battery may be housed within a battery pack housing which is itself detachable from the remainder of the golf trolley 10. For example, a removable battery pack may be provided for discrete charging thereof, or for replacement.

The second chassis segment 24 includes a connector 30 arranged to reversibly connect the second chassis segment 24 to the first chassis segment 20. The connector 30 is configured to engage a corresponding connector (not shown) located at the first chassis segment 20.

The connector halves may each include corresponding halves of an electronic connector. The electronic connector may be a wired or wireless connector, e.g. Bluetooth (RTM). For example, the first chassis segment 20 or the frame 12 may comprise powerable components configured to be powered by the battery located at the second chassis segment 24. The electrical connector formed by the electrical connector halves may, for example, include corresponding electrical contacts which are configured to reversibly operably engage one another when the modular segments 20, 24 are attached so that powerable components located on one chassis segment on the frame may be powered by a battery located on the other chassis segment.

In order to initiate separation of the chassis segments 20, 24, the golf trolley 10 comprises a release mechanism (not shown) actuable by a user during a normal use configuration of the trolley 10, e.g. prior to or following play. The release mechanism may be located on either the first 20 or the second 24 chassis segment. In the embodiment of FIG. 1, the release mechanism is located on the second chassis segment 24.

Thus, the golf trolley 10 is biased towards a lock position when the first and second chassis segments 20, 24 are connected. In the lock position, the modules are substantially prevented from being separated without the actuation of the release mechanism.

It is envisaged, as in FIGS. 3 through 10, that the frame 12 of the golf trolley 10 may also constitute an additional separable module which is reversibly detachable from the base 14. However, in FIG. 1, the frame 12 is substantially permanently attached to the base 14.

The separability of the first and second chassis segments 20, 24 allows different chassis modules to be joined. For example, the rear second chassis segment 24, which in FIG. 1 is an electric module, may be swapped for a non-electric, i.e. push-type rear second chassis segment. The push-type rear second chassis segment may be similar to the electric module in that the general dimensions are comparable. The interchangeable modules are dissimilar in that the push-type module does not include a battery and/or powerable components configured for powering driven wheels.

Separate chassis modules (and/or the frame) may therefore be packaged independently so that a golfer may acquire modules separately or together. Where the frame also comprises one or more detachable modules, these may also be separately packaged. For example, a module including a steering means may be separately packaged from the base and/or from distinct frame modules.

The base 14 includes a hinged joint 32 between the modular first and second chassis segments 20, 24 which is arranged such that, during a transition between the deployed and collapsed configurations of the golf trolley 10, the adjacent chassis segments fold relative to one another.

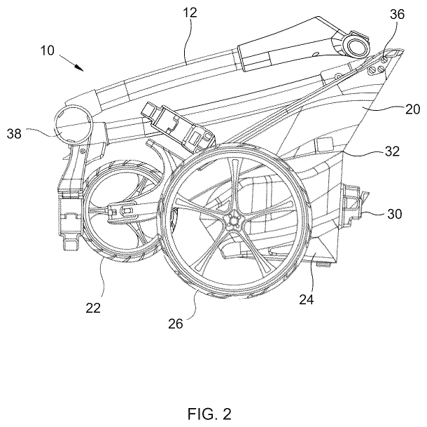

More specifically, and with reference to FIG. 2, during a transition between the deployed configuration and the collapsed configuration the second, i.e. rear, chassis segment 24 moves relative to the first, i.e. front, chassis segment 20 and the frame 12. The first chassis segment 20 generally rotates relative to the non-drive wheel attachment 22 of the first chassis segment 20, which is substantially static on the ground during a said transition.

The golf trolley 10 is configured such that, in the collapsed configuration, the front chassis segment 20 is positioned, i.e. lies, between the frame 12 and the second chassis segment 24. An underside of the second chassis segment 24 substantially faces an underside of the first chassis segment 20 in the collapsed configuration. Also in the collapsed configuration, the wheels of the second chassis segment 24 substantially flank the first chassis segment 20.

As described, the frame 12 and the second chassis segment 24 are each hingedly connected to the first chassis segment 20. The second chassis segment 24 is hingedly connected to the first chassis segment 20 via hinged joint 32 and the frame 12 is hingedly connected to the first chassis segment 20 via hinged joint 36. Both hinged joints 32, 36 are located towards the rear of the first chassis segment 20. A hinged joint 38 joins the upper 13 and lower 18 portions of the frame 12.

The golf trolley 10 is arranged such that, during a transition between the deployed configuration and the collapsed configuration the frame 12 rotates about hinged joint 36 in a first direction. The second chassis segment 24 rotates about hinged joint 32 in a second direction which is different to the first direction. In FIG. 2, the frame 12 rotates substantially anticlockwise relative to the first chassis segment 20 whereas the second chassis segment 24 rotates substantially clockwise relative to the first chassis segment 20.

Generally, movement of the frame 12 relative to the first chassis segment 20 and movement of the second chassis segment 24 relative to the first chassis segment 20 is substantially interdependent during a transition between the deployed and collapsed configurations.

More specifically, a one-step folding and unfolding mechanism is provided for interdependently folding the frame 12 and second base segment 24 relative to the first chassis segment 20 during a transition from the deployed configuration to the collapsed configuration and for unfolding the frame 12 and second base segment 24 during a transition from the collapsed configuration to the deployed configuration. A single actuator (not shown), e.g. lever, is provided for actuating the one-step folding mechanism. Alternatively, a two-step folding and unfolding mechanism may be provided for substantially independent folding and unfolding of the frame 12 and second base segment 24.

Thus, the second, i.e. rear, chassis segment 24 is not only foldable relative to the rest of the golf trolley 10 in such a way that the golf trolley is more compact in a collapsed configuration, but the rear chassis segment 24 of the golf trolley 10 is reversibly separable from the front chassis segment 20 to facilitate the substitution of push-type and electric rear chassis segments. Therefore, the golf trolley 10 can be straightforwardly converted from a push-type foldable golf trolley to an electric foldable golf trolley, and vice versa.

The golf trolley 100 of FIG. 3 includes a frame 112 and a base 114 wherein the base 114 includes at least first 120 and second 124 chassis modules and the frame 112 includes a number of reversibly separable modules.

More specifically, in the golf trolley of FIG. 3, the frame 112 includes two modules: a first module comprising upper 113 and lower 118 frame portions; and a second module comprising a steering means 116. Thus, both base and frame modules may be separately packaged and therefore acquired and reversibly attached to one another to form a substantially customisable golf trolley.

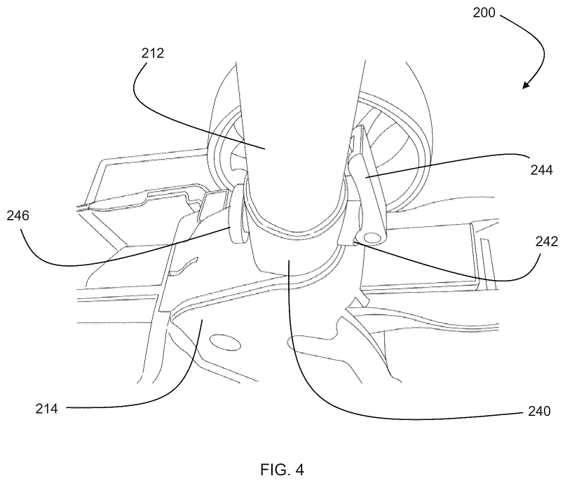

FIGS. 4 through 10 illustrate the means by which a frame module 212 is reversibly and repeatable separable from the base 214 of the modular golf trolley 200. It is envisaged that the frame may constitute a single frame module or, alternatively, the frame may comprise a plurality of connectable frame modules.

Referring to FIG. 4, the frame module 212 is received by a socket (not shown) of the base 214. A bounding wall 240 protrudes from the socket and bounds the frame module 212 about substantially the entire circumference thereof. The frame 212 and base 214 are semi-permanently attached to one another.

The modular golf trolley 200 comprises a locking means (or lock) 242. The locking means 242 is configured to transition between a locked configuration and an unlocked configuration. In the locked configuration, the locking means 242 is configured to maintain the semi-permanent attachment of the frame module 212 and the base 214. In the unlocked configuration, the locking means 242 is configured to permit reversible separation of the frame module 212 and the base 214.

The locking means 242 is in the form of a cam lever clamp, which allows a transition between the locked and unlocked configurations of the locking means 242 without the need for a distinct tool. The cam lever clamp is configured to be operably engaged by the hand of a user, in use. In the locked configuration thereof, the locking means 242 squeezes, i.e. compresses, the frame module and base against one another.

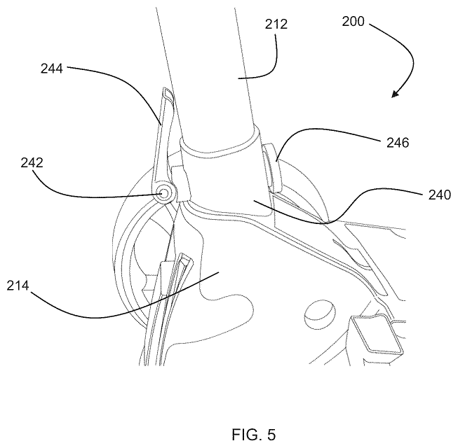

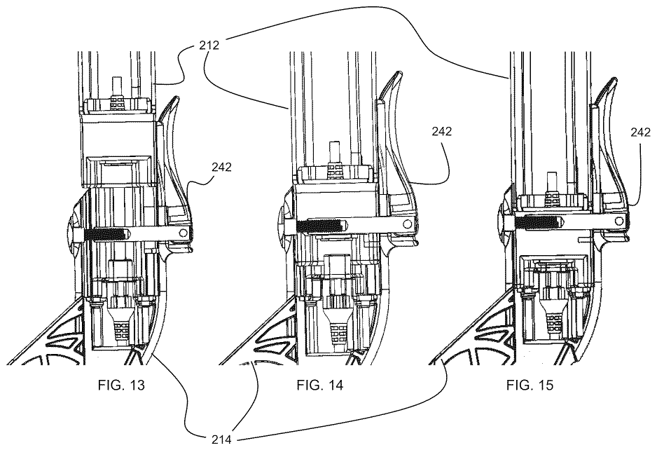

FIGS. 4 and 5 show the locking means in the locked configuration, whereas FIG. 6 shows the locking means in the unlocked configuration. In the configuration of FIG. 6, the frame module 212 is permitted to be separated, e.g. lifted, from the base 214. Turning to FIGS. 13, 14 and 15, it can be seen in FIG. 13 that the base 214 and frame modules 212 are physically and electrically separate. In FIG. 14 the base 214 and frame modules 212 are physically connected but electrically separate. In FIG. 15 the base 214 and frame modules 212 are both physically and electrically connected. In each of FIGS. 13, 14 and 15 the locking means 242 is in a locked configuration. In other words, the locking means 242 is arranged so that the frame 212 and base modules 214 may be physically connected to one another but electrically separated and the locking means 242 can hold the frame 212 and base 214 modules together in that electrically separate arrangement.

The cam lever clamp may be loosened or tightened, to alter the compression force applied to the frame module 212 and base 214 in the locked configuration, by rotating, e.g. screwing, the lever thereof 244 relative to an end nut 246.

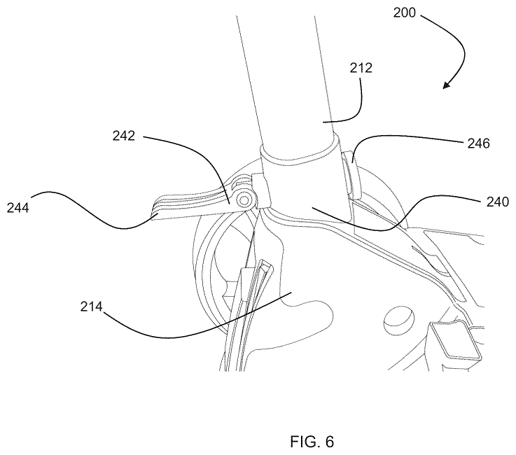

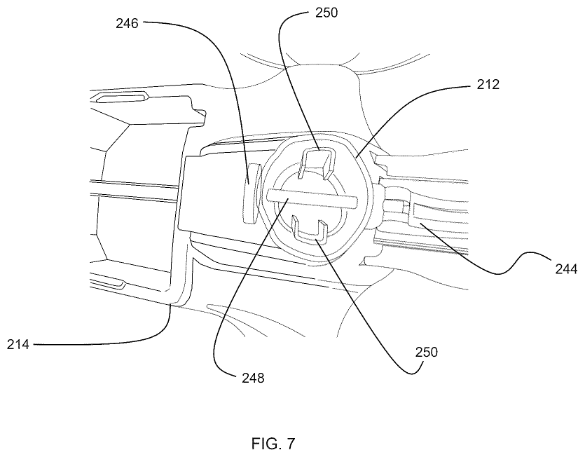

FIG. 7, which illustrates a top down view of the base 214, shows that the locking means 242 includes a rod 248 which passes through openings of the base 214. The lever 244 and the end nut 246 are located at substantially opposite sides of the bounding wall 240. A pair of stays 250 aids alignment of the frame module 212 as the frame module 212 and base 214 are connected. The locking means 242 thus remains part of the base 214 when the frame module 212 and base 214 are separate.

Turning to FIG. 8, it can be seen that a bottom end of the frame module 212 also includes an opening 252 configured to receive the rod 248 of the locking means 242. The opening 252 of the frame module 212 is in the form of a slot which extends from an extremity of the frame module 212. The slot 252 is open so that the frame module 212 may be straightforwardly separated (e.g. by lifting) from the base 214 once the locking means 242 has transitioned to the unlocked configuration.

Referring still to FIG. 8, it can be seen that the frame module 212 includes an electrical connector 254 configured to operably engage a corresponding connector of the base (not shown).

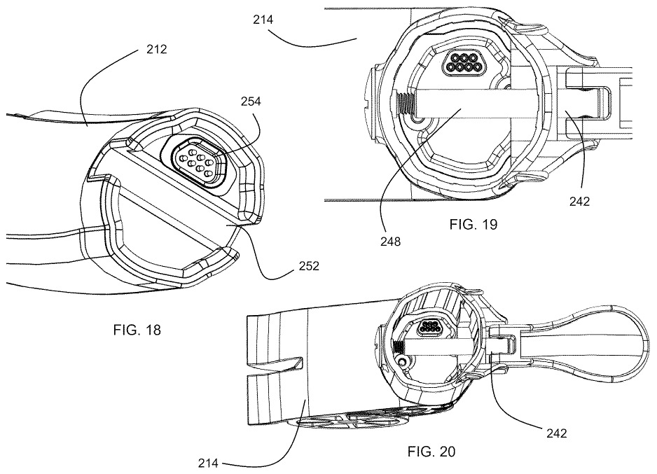

FIGS. 18, 19 and 20 also show the electrical connector halves of the frame portion 212 and base 214. FIGS. 18, 19 and 20 also show how the socket configured to receive the frame member 212 has a substantially non-circular axial cross section in order to aid correctly oriented insertion of the frame member by a user.

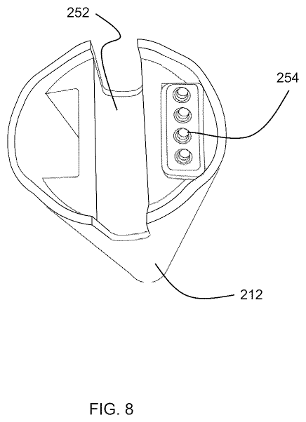

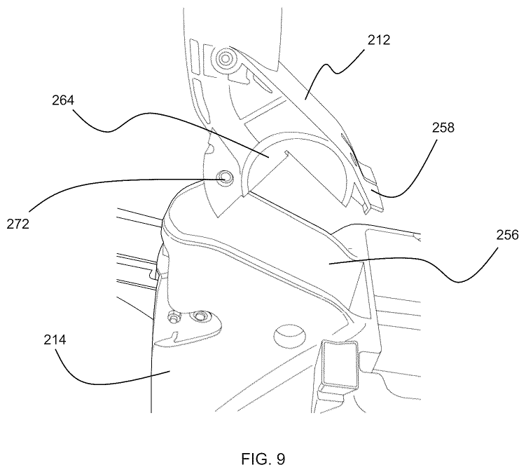

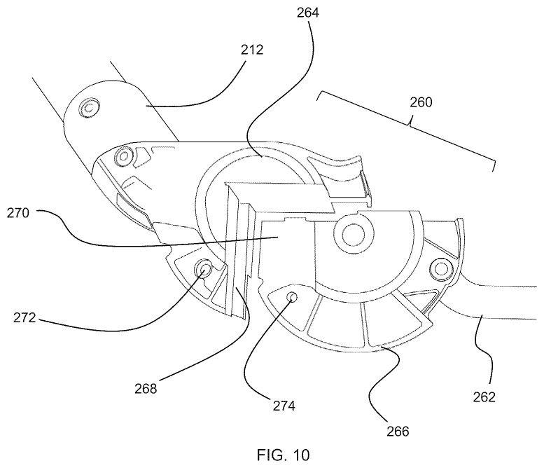

FIGS. 9 and 10 show another embodiment of a module golf trolley.

In the embodiment of FIGS. 9 and 10, the chassis of the base 214 includes a cut out 256 and the frame module 212 includes a portion 258 which substantially occludes the cut out 256 when the frame module 212 and base 214 are semi-permanently attached to one another.

The frame module 212 and the base 214 each include openings, such as 272, 274, which are configured to receive two rods (not shown) which, when fixed, semi-permanently attach the frame module 212 to the base 214.

A first rod is received substantially axially by the frame module 212 and the base 214. The first rod may also act as a shaft about which the frame module 212 may rotate relative to the base 214 during a transition between deployed and folded configurations, where the modular golf trolley is a foldable golf trolley. A second rod is received down through the occluding portion 258 into a portion of the base.

As shown in FIG. 10, the modular golf trolley 200 comprises a cam 260 which is mechanically associated with the folding and unfolding of the modular golf trolley 200. More specifically, the cam 260 is associated with folding a first chassis module including a front wheel attachment of the trolley relative to a second chassis module, via a connecting bar 262.

The cam 260 is formed by interfacing portions 264, 266 of the frame module 212 and the base 214. The frame module portion 264 includes a recess 268 and the base portion 266 includes a corresponding tooth 270. The tooth 270 is configured to operably engage the recess 268 such that, in the locked configuration of the locking means 242, relative movement of the frame module portion 264 and base portion 266 is substantially prevented.

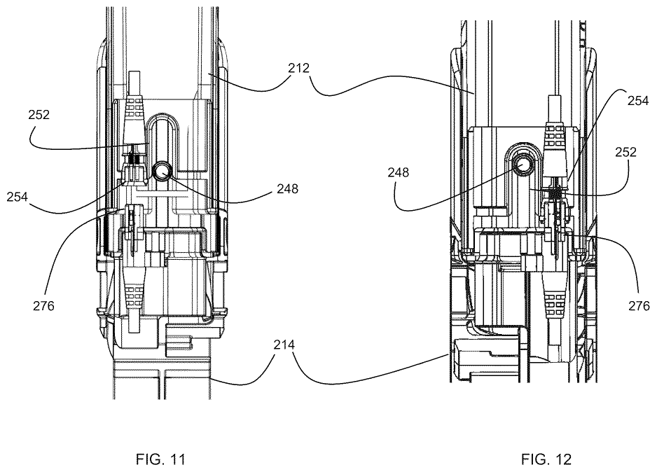

FIGS. 11 and 12 illustrate a modular golf trolley where frame 212 and base 214 modules are in an electrically disconnected configuration (FIG. 11) and an electrically connected configuration (FIG. 12). The frame 212 and base 214 modules each include corresponding electrical connector halves (e.g. a plug and socket). The frame module 212 and base 214 each include electrical connector halves 254, 276. It can also be seen how the rod 248 of the locking means 242 is received by the slot 252 of the frame module 212.

In the modular golf trolley of FIGS. 11 and 12, the connector halves of the frame 212 and base 214 modules include make-last-break-first (MLBF) contacts. In other words, the connector halves each include a power contact and one or more non-power contacts (e.g. data contacts), wherein the power contacts are configured to make contact with one another only substantially after each of the non-power contacts have contact one another, and the power contacts are configured to separate substantially before each of the non-power contacts separate. More specifically, the power contacts may be shorter in length than the non-power contacts in order that they contact one another only after the non-power contacts of the frame and base modules are connected.

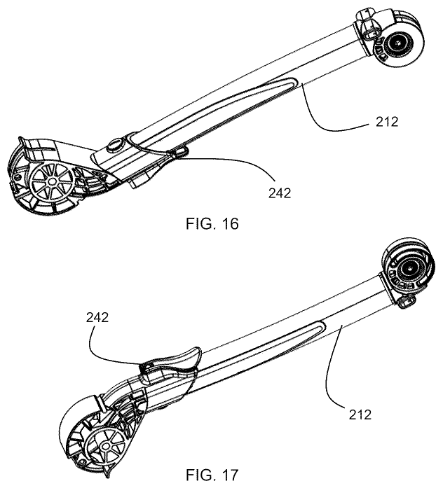

FIGS. 16 and 17 illustrate a frame module 212 connected to a further module ultimately forming part of the base 214 by the locking means 242. The further module may also be semi-permanently attachable to the remainder of the base or may form a substantially permanent part of the base 214.

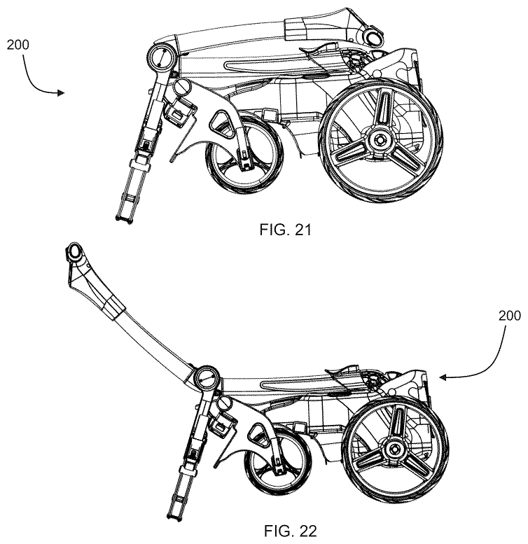

FIGS. 21 through 24 illustrate a modular golf trolley 200 having a frame module 212 separable from the base 214 of the trolley. In FIG. 21, the frame module 212 is attached to the base 214 of the trolley 200 and the trolley 200 is in a folded configuration. The locking means 242 is in a locked configuration, so separation of the frame module 212 from the base 214 is substantially prevented. In FIG. 22, the trolley 200 is partially folded, i.e. two frame modules are substantially unfolded but the frame 212 is still folded relative to the base 214, and a front segment of the base is folded relative to the remainder of the base. The locking means 242 is still in a locked configuration.

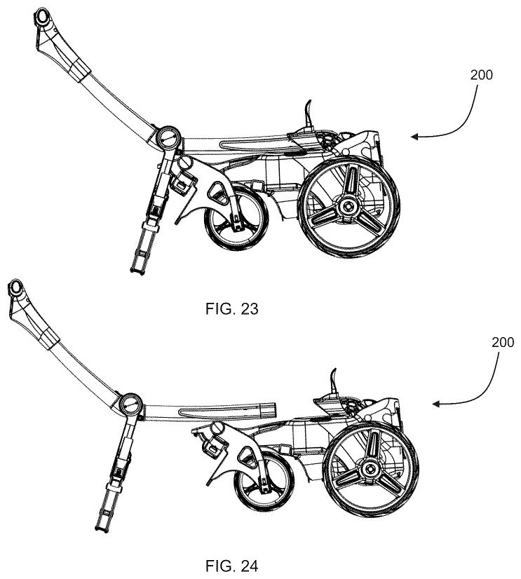

In FIG. 23, the locking means 242 is in an unlocked configuration. Therefore, separation of the frame module 212 from the base 214 of the modular trolley is substantially permitted. In FIG. 24, the frame 212 is separate from the base 214 of the trolley. Thus, the same or a different frame (e.g. a frame including a different handlebar) can be substituted for the removed frame. This way, different modules can be combined to provide modular golf trolleys having different characteristics.

### Clauses of the Invention

1. A modular golf trolley comprising a frame and a base having a chassis comprising at least first and second separable chassis modules; wherein the chassis modules are reversibly separable from one another in a normal use configuration of the modular golf trolley.
2. The modular golf trolley according to clause 1, wherein the first chassis module is a front chassis module including one or more front wheel attachments; and the second chassis module is a rear chassis module including one or more rear wheel attachments; optionally, wherein the front chassis module is mechanically associated with the frame.
3. The modular golf trolley according to clause 2, wherein the second chassis module is either:
   a. a push-type module including one or more non-powered wheel attachments; or
   b. an electric module including one or more powerable wheel attachments and, optionally, a battery and/or one or more powerable components; and
wherein, preferably, the first chassis module is configured to substantially interchangeably and reversibly engage with the rear chassis module of a. and/or b.
4. The modular golf trolley according to any preceding clause, wherein the first chassis module comprises an electrical-connector-half configured to operably engage a corresponding electrical-connector-half on the second chassis module in an assembled state of the modular golf trolley.
5. The modular golf trolley according to any preceding clause, wherein the frame comprises a module which is reversibly separable from the base; optionally wherein the frame includes a plurality of modules which are reversibly separable from one another.
6. The modular golf trolley according to any preceding clause, wherein the golf trolley is a foldable golf trolley having a deployed configuration and a collapsed configuration.

7. The modular golf trolley according to clause 6, wherein the golf trolley comprises one or more joints about which the golf trolley folds, in use, during a transition between the deployed and collapsed configurations; and, preferably, at least one said joint is arranged substantially at or immediately adjacent the juncture between adjacent chassis modules such that the adjacent chassis modules fold relative to one another during a said transition.
8. The modular golf trolley according to clause 7, wherein at least part of the frame is configured to move relative to the base during a transition between the deployed configuration and the collapsed configuration; and whereby, preferably, during a transition from the deployed configuration towards the collapsed configuration and/or during a transition from the collapsed configuration towards the deployed configuration, movement of the frame relative to the base and movement of the adjacent chassis modules is substantially interdependent.
9. A chassis module for the modular golf trolley according to any of clauses 1 to 8; wherein the chassis module is configured to reversibly engage a distinct corresponding chassis module in a normal use configuration of the modular golf trolley.
10. The chassis module according to clause 9, wherein the chassis module is mechanically associated with frame of the modular golf trolley.
11. The chassis module of clause 9 or clause 10, wherein the chassis module is either:
   a. a push-type module including one or more non-powered wheel attachments; or
   b. an electric module including one or more powerable wheel attachments and, optionally, a battery and/or one or more powerable components.
12. A kit for a modular golf trolley comprising two or more modules according to any of clauses 9 to 11 or a single such module and instructions to combine it with another such module.
13. A foldable golf trolley comprising a frame and a base including a first chassis segment including one or more front wheel attachments and a second chassis segment including one or more rear wheel attachments; wherein the foldable golf trolley is configured to transition between a deployed configuration and a collapsed configuration; wherein, the frame substantially extends from the first chassis segment in the deployed configuration; and whereby, during a transition between the deployed configuration and the collapsed configuration the second chassis segment moves relative to the first chassis segment and the frame.
14. The foldable golf trolley according to clause 13, wherein the foldable golf trolley is configured such that, in the collapsed configuration, the first chassis segment is positioned between the frame and the second chassis segment.
15. The foldable golf trolley according to clause 13 or clause 14, wherein the foldable golf trolley is an electric golf trolley; and, preferably, wherein the second chassis segment comprises a battery and the one or more wheel attachments thereof are powerable, i.e. motorised, wheel attachments.
16. The foldable golf trolley according to any of clauses 13 to 15, wherein the first chassis segment comprises a first electrical connector and the second chassis segment comprises a corresponding second electrical connector; wherein, preferably, the electrical connectors are configured to operably engage one another in the deployed configuration of the foldable golf trolley.
17. The foldable golf trolley according to any of clauses 13 to 16, whereby, during a transition from the deployed configuration towards the collapsed configuration and/or during a transition from the collapsed configuration towards the deployed configuration, at least part of the frame moves relative to the first chassis segment; and movement of the frame relative to the first chassis segment and movement of the second chassis segment relative to the first chassis segment and the frame is substantially interdependent.
18. The foldable golf trolley according to any of clauses 13 to 17, wherein the second chassis segment is hingedly connected to the first chassis segment at or towards an underside of the base by a hinged connection; and whereby, preferably, during a transition from the deployed configuration towards the collapsed configuration the second chassis segment is configured to rotate about the hinged connection such that, in the collapsed configuration, an underside of the second chassis segment substantially faces an underside of the first chassis segment of the base.
19. The foldable golf trolley according to any of clauses 13 to 18, wherein the second chassis segment includes a pair of rear wheel attachments; and wherein, preferably, the foldable golf trolley is configured such that, in the collapsed configuration, the pair of rear wheel attachments substantially flank the first chassis segment.
20. The foldable golf trolley according to any of clauses 13 to 19, wherein the second chassis segment is a separable module which is reversibly separable from the rest of the golf trolley in a normal use configuration of the golf trolley.
21. The foldable golf trolley according to clause 20, wherein the separable module is either:
a. a push-type module including one or more non-powered wheel attachments; or
b. an electric module including one or more powerable wheel attachments and, optionally, a battery and/or one or more non-wheel powerable components; and
wherein, preferably, the first chassis segment is configured to substantially interchangeably and reversibly attach to the second chassis segment of a. and/or b.
22. The foldable golf trolley according to any of clauses 13 to 21, wherein the frame comprises a module which is reversibly separable from the base; optionally wherein the frame includes a plurality of modules which are reversibly separable from one another.
23. A modular golf trolley comprising a frame and a base, the frame and base each comprising at least one module;
   wherein a said frame module is semi-permanently attachable to the base;
   the modular golf trolley comprising a locking means arranged, in a locked configuration thereof, to maintain the semi-permanent attachment of the frame module to the base; and, in an unlocked configuration thereof, to permit reversible separation of the frame module from the base.
24. The modular golf trolley according to clause 23, wherein the locking means is operable in a normal use configuration of the modular golf trolley.
25. The modular golf trolley according to clause 23 or clause 24, wherein the locking means is arranged to substantially remain as part of the frame module and/or the base in the unlocked configuration thereof.
26. The modular golf trolley according to of clauses 23 to 25, wherein the locking means comprises a quick release clamp.
27. The modular golf trolley according to any of clauses 23 to 26, wherein the locking means is biased towards the locked configuration thereof.
28. The modular golf trolley according to any of clauses 23 to 27, wherein the modular golf trolley is an electric golf trolley including a battery and one or more powerable components; and wherein the frame module includes an electrical connector configured to operably engage a corresponding electrical connector of the base when the locking means is in the locked configuration.
29. The modular golf trolley according to clause 28, wherein the modular golf trolley is arranged such that the battery is substantially electrically isolated in the absence of the semi-permanent attachment of the frame module and base.
30. The modular golf trolley according to any of clauses 23 to 29, wherein the frame module or the base includes a socket arranged to receive a portion of the other of the frame module and base; and, optionally, further comprises a wall protruding from the socket, the wall being configured to substantially circumferentially bound the other of the frame module and base.
31. The modular golf trolley according to any of clauses 23 to 30, wherein the base comprises a chassis including a cut out, and the frame module includes a portion which substantially occludes the cut out when the frame module is semi-permanently attached to the base.
32. The modular golf trolley according to any of clauses 23 to 31, wherein the modular golf trolley is a foldable golf trolley which is reversibly deployable from a collapsed configuration to a deployed configuration.
33. The modular golf trolley according to clause 32, comprising a cam mechanically associated with the folding and unfolding of the modular golf trolley; wherein, preferably, the cam is includes interfacing portions of the frame module and base.
34. The modular golf trolley according to clause 33, wherein one of the frame module and base includes a recess and the other includes a corresponding protrusion, e.g. tooth, configured to operably engage the recess, preferably, such that, in the locked configuration of the locking means, relative movement of the frame module portion and base portion is substantially prevented.
35. The modular golf trolley according to any of clauses 23 to 34, wherein the locking means comprises a rod and the frame module and base each include one or more openings configured to receive the rod; further optionally, wherein a said opening of the frame module is formed as a slot extending from an extremity thereof.
36. The modular golf trolley according to any of clauses 23 to 35, wherein the frame includes an upper portion and lower portion of the frame which are pivotally connected to one another, and a steering means; and
wherein the upper portion, lower portion, and steering means substantially comprise one frame module; or
wherein the upper portion, lower portion, and steering means comprise two or more reversibly separable frame modules which are reversibly separable in a normal use configuration of the modular golf trolley.
37. The modular golf trolley according to any of clauses 23 to 36, wherein the base comprises a chassis including at least first and second separable chassis modules; wherein the chassis modules are reversibly separable from one another in a normal use configuration of the modular golf trolley.

38. A frame module for the modular golf trolley according to any of clauses 23 to 37; wherein the frame module is configured to be semi-permanently attached to a base module.
39. A base module for the modular golf trolley according to any of clauses 23 to 37; wherein the base module is configured to be semi-permanently attached to a frame module.
40. A kit for a golf trolley according to any of clauses 1 to 37; comprising at least one frame module according to any preceding clause and/or at least one base module according to any preceding clause.
41. The kit according to clause 40, comprising at least one base module; optionally, wherein the kit comprises first and second chassis modules.
42. The kit according to cause 40 or clause 41, wherein the kit is a starter kit for a modular golf trolley, preferably comprising at least one base module and at least one frame module, further preferably wherein the or each base module and the or each frame module of the starter kit are configured to be assembled into a substantially driveable modular golf trolley.
43. A method of assembling a modular golf trolley comprising the steps of:
   a) providing at least one frame module, at least one base module, and a locking means;
   b) connecting a said frame module to a said base module;
   c) transitioning the locking means from an unlocked configuration, in which reversible separation of the frame module and base module is substantially permitted, to a locked configuration in which the frame module and base module are semi-permanently attached to one another.
44. The method of clause 43, wherein step c) is reversible and repeatable.
45. The method of clause 43 or clause 44, wherein step c) occurs in a normal use configuration of the modular golf trolley.
46. The method of any of clauses 44 to 45, wherein the locking means remains as at least part of the golf frame module and/or base module during a transition from the locked configuration to the unlocked configuration.
47. The method of any of clauses 43 to 46, wherein the locking means comprises a quick-release clamp.
48. The method of any of clauses 43 to 47, wherein the modular golf trolley is an electric golf trolley wherein the base includes a battery and the frame module has one or more powerable components; and step b) and/or step c) includes electrically connecting the one or more powerable components to the battery.
49. The method of clause 48, wherein during a transition from the locked configuration to the unlocked configuration of the locking means, the battery is electrically isolated.

1. A modular golf trolley comprising:
a frame and a base, the frame and base each comprising at least one module; wherein said module of the frame is semi-permanently attachable the base; and
a locking means arranged, in a locked configuration thereof, to maintain the semi-permanent attachment of the frame module to the base; and, in an unlocked configuration thereof, to permit reversible separation of the frame module from the base.

2. The modular golf trolley according to claim 1, wherein the locking means is operable in a normal use configuration of the modular golf trolley.

3. The modular golf trolley according to claim 1, wherein the locking means is arranged to substantially remain as part of the frame module and/or the base in the unlocked configuration thereof; wherein the locking means comprises a quick release clamp.

4. The modular golf trolley according to claim 1, wherein the locking means is biased towards the locked configuration thereof.

5. The modular golf trolley according to claim 1, wherein the modular golf trolley is an electric golf trolley; and wherein the frame module includes an electrical connector configured to operably engage a corresponding electrical connector of the base; wherein the modular golf trolley includes a battery and one or more powerable components and is arranged such that the battery is substantially electrically isolated in the absence of the semi-permanent attachment of the frame module and base.

6. The modular golf trolley according to claim 5, wherein the electrical connectors include one or more make-last-break-first power contacts.

7. The modular golf trolley according to claim 1, wherein the locking means comprises a rod and the frame module and the base each include one or more openings configured to receive the rod; wherein one of the openings of the frame module is formed as a slot extending from an extremity thereof.

8. The modular golf trolley according to claim 1, wherein the frame includes an upper portion and lower portion of the frame which are pivotally connected to one another, and a steering means; and
wherein either the upper portion, lower portion, and steering means substantially comprise one frame module; or
wherein the upper portion, lower portion, and steering means comprise two or more reversibly separable frame modules which are reversibly separable in a normal use configuration of the modular golf trolley.

9. The modular golf trolley according to claim 1, wherein the modular golf trolley is a foldable golf trolley which is reversibly deployable from a collapsed configuration to a deployed configuration.

10. A frame module for the modular golf trolley according to claim 1, wherein the frame module is configured to be semi-permanently attachable to a base module.

11. A method of assembling a modular golf trolley comprising the steps of:
a) providing at least one frame module, at least one base module, and a locking means;
b) connecting said frame module to said base module;
c) transitioning the locking means from an unlocked configuration, in which reversible separation of the frame module and base module is substantially permitted, to a locked configuration in which the frame module and base module are semi-permanently attached to one another.

12. The method of claim 11, wherein step c) is reversible and repeatable.

13. The method of claim 11, wherein step c) occurs in a normal use configuration of the modular golf trolley.

14. The method of claim 11, wherein the modular golf trolley is an electric golf trolley wherein the base includes a battery and the frame module has one or more powerable components; and step b) and/or step c) includes electrically connecting the one or more powerable components to the battery;
wherein during a transition from the locked configuration to the unlocked configuration of the locking means, the battery is electrically isolated.

15. A modular golf trolley comprising a frame and a base having a chassis comprising at least first and second separable chassis modules; wherein the chassis modules are reversibly separable from one another in a normal use configuration of the modular golf trolley.

16. The modular golf trolley according to claim 15, wherein the first chassis module is a front chassis module including one or more front wheel attachments; and the second chassis module is a rear chassis module including one or more rear wheel attachments; wherein the front chassis module is mechanically associated with the frame.

17. The modular golf trolley according to claim 16, wherein the second chassis module is either:
a. a push-type module including one or more non-powered wheel attachments; or
b. an electric module including one or more powerable wheel attachments and, battery and/or one or more powerable components; and
wherein the first chassis module is configured to substantially interchangeably and reversibly engage with the rear chassis module of a. or b.

18. The modular golf trolley according to claim 15, wherein the first chassis module comprises an electrical connector configured to operably engage a corresponding electrical connector on the second chassis module in an assembled state of the modular golf trolley.

19. The modular golf trolley according to claim 15, wherein the golf trolley is a foldable golf trolley having a deployed configuration and a collapsed configuration.

20. The modular golf trolley according to claim 19, wherein the golf trolley comprises one or more joints about which the golf trolley folds, in use, during a transition between the deployed and collapsed configurations; and at least one said joint is arranged substantially at the juncture between adjacent chassis modules such that the adjacent chassis modules fold relative to one another during said transition; wherein at least part of the frame is configured to move relative to the base during a transition between the deployed configuration and the collapsed configuration; and whereby, during a transition from the deployed configuration towards the collapsed configuration and/or during a transition from the collapsed configuration towards the deployed configuration, movement of the frame relative to the base and movement of the adjacent chassis modules is substantially interdependent.

21. A chassis module for the modular golf trolley according to claim 15, wherein the chassis module is configured to reversibly engage a distinct corresponding chassis module in the normal use configuration of the modular golf trolley.

22. The chassis module according to claim 21, wherein the chassis module is mechanically associated with frame of the modular golf trolley.

23. The chassis module of claim 21, wherein the chassis module is either:
a. a push-type module including one or more non-powered wheel attachments; or
b. an electric module including one or more powerable wheel attachments and, a battery and/or one or more powerable components.

24. A kit for a modular golf trolley according to claim 15, comprising two or more of said modules.

25. A foldable golf trolley comprising a frame and a base including a first chassis segment including one or more front wheel attachments and a second chassis segment including one or more rear wheel attachments; wherein the foldable golf trolley is configured to transition between a deployed configuration and a collapsed configuration; wherein, the frame substantially extends from the first chassis segment in the deployed configuration; and whereby, during a transition between the deployed configuration and the collapsed configuration the second chassis segment moves relative to the first chassis segment and the frame.

26. The foldable golf trolley according to claim 25, wherein the foldable golf trolley is configured such that, in the collapsed configuration, the first chassis segment is positioned between the frame and the second chassis segment.

27. The foldable golf trolley according to claim 25, wherein the foldable golf trolley is an electric golf trolley; and wherein the second chassis segment comprises a battery and the one or more wheel attachments thereof are powerable wheel attachments.

28. The foldable golf trolley according to claim 25, wherein the first chassis segment comprises a first electrical connector and the second chassis segment comprises a corresponding second electrical connector; wherein the electrical connectors are configured to operably engage one another in the deployed configuration of the foldable golf trolley.

29. The foldable golf trolley according to claim 25, wherein the second chassis segment is hingedly connected to the first chassis segment at or towards an underside of the base by a hinged connection; and whereby, during a transition from the deployed configuration towards the collapsed configuration the second chassis segment is configured to rotate about the hinged connection such that, in the collapsed configuration, an underside of the second chassis segment substantially faces an underside of the first chassis segment of the base.

30. The foldable golf trolley according to claim 25, wherein the second chassis segment includes a pair of rear wheel attachments; and wherein the foldable golf trolley is configured such that, in the collapsed configuration, the pair of rear wheel attachments substantially flank the first chassis segment.

31. The foldable golf trolley according to claim 25, wherein the second chassis segment is a separable module which is reversibly separable from a remainder of the golf trolley in a normal use configuration of the golf trolley; wherein the separable module is either:
a. a push-type module including one or more non-powered wheel attachments; or
b. an electric module including one or more powerable wheel attachments and, a battery and/or one or more powerable components; and
wherein the first chassis segment is configured to substantially interchangeably and reversibly attach to the second chassis segment of a. and/or b.
